(19) United States
(12) Patent Application Publication
(10) Pub. No.: US 2026/0109356 A1
(43) Pub. Date: Apr. 23, 2026

(54) INFORMATION PROCESSING APPARATUS

(71) Applicant: SUBARU CORPORATION, Tokyo (JP)

(72) Inventors: Shuhei WADA, Tokyo (JP); Takeshi TORII, Tokyo (JP); Noeru SATO, Tokyo (JP); Yuki MIZUHARA, Tokyo (JP)

(21) Appl. No.: 19/352,887

(22) Filed: Oct. 8, 2025

(30) Foreign Application Priority Data
Oct. 17, 2024 (JP) 2024-181480

(51) Int. Cl. B60W 40/09; B60W 50/14

(52) U.S. Cl. CPC B60W 40/09; B60W 50/14; B60W 2050/143; B60W 2050/146; B60W 2540/30; B60W 2552/00

(57) ABSTRACT

An information processing apparatus calculates a difficulty level of a predetermined route and includes one or more processors and one or more memories communicably coupled to the one or more processors. The one or more processors are configured to: determine an attribute of the predetermined route; acquire information about a plurality of routes each having an attribute similar to the determined attribute; calculate a first probability distribution, indicating an occurrence tendency of a value indicated by at least one first indicator related to a geographical feature in all of the routes, based on the acquired information about the routes; and calculate the difficulty level of the predetermined route based on a position, in the first probability distribution, of the value indicated by the at least one first indicator at a predetermined point or in a predetermined section included in the predetermined route.

### CROSS-REFERENCE TO RELATED APPLICATIONS

The present application claims priority from Japanese Patent Application No. 2024-181480 filed on Oct. 17, 2024, the entire contents of which are hereby incorporated by reference.

### BACKGROUND

The present disclosure relates to information processing apparatuses, and particularly, to an information processing apparatus that calculates a difficulty level of a predetermined route.

In the related art, a technology for evaluating a difficulty level of a travel route of a vehicle is known.

For example, Japanese Unexamined Patent Application Publication (JP-A) No. 2015-169612 discloses a navigation device including a map information recording unit that records map information, a route search unit that searches for a route to a destination designated by a driver using the map information, a corner extraction unit that extracts corners in the searched route, a corner difficulty estimation unit that estimates the difficulty level of each extracted corner based on a driving skill, a route difficulty evaluation unit that evaluates the difficulty level of the route based on the estimated difficulty levels of the corners, and a display unit that displays the searched route and the evaluated difficulty level of the route. In addition, JP-A No. 2015-169612 discloses that a standard deviation of the difficulty level of each corner is calculated, and when a route candidate includes a corner that exceeds the range of the standard deviation, the route candidate is evaluated as a more difficult route than a route candidate that does not include the corner.

### SUMMARY

An aspect of the disclosure provides an information processing apparatus configured to calculate a difficulty level of a predetermined route and including one or more processors and one or more memories communicably coupled to the one or more processors. The one or more processors are configured to: determine an attribute of the predetermined route; acquire information about a plurality of routes each having an attribute similar to the determined attribute; calculate a first probability distribution, indicating an occurrence tendency of a value indicated by at least one first indicator related to a geographical feature in all of the routes, based on the acquired information about the routes; and calculate the difficulty level of the predetermined route based on a position, in the first probability distribution, of the value indicated by the at least one first indicator at a predetermined point or in a predetermined section included in the predetermined route.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating a configuration example of a system to which an information processing apparatus according to an embodiment of the present disclosure is applicable;

FIG. 2 is a schematic diagram illustrating a configuration example of a vehicle capable of communicating with the information processing apparatus according to the embodiment of the present disclosure;

FIG. 3 is a block diagram illustrating a configuration example of the information processing apparatus according to the embodiment of the present disclosure;

FIG. 4 is a diagram for explaining a plurality of routes to be considered for calculating a difficulty level;

FIG. 5 is a diagram for explaining a predetermined route for which the difficulty level is to be calculated;

FIG. 6 is a diagram for explaining the level division of the difficulty level;

FIG. 7 is a flowchart for explaining an operation example of the information processing apparatus according to the embodiment of the present disclosure;

FIG. 8 is a flowchart for explaining the details of a difficulty level calculation process in the operation example illustrated in FIG. 7; and

FIG. 9 is a flowchart for explaining an operation example of the information processing apparatus according to an embodiment of the present disclosure.

### DETAILED DESCRIPTION

The related art as disclosed in JP-A No. 2015-169612 is problematic in that, even when the difficulty level of a corner in a route candidate is not higher than the difficulty levels of corners of various routes similar to the route candidate, if the difficulty level of the corner in the route candidate is outside the range of the standard deviation, the route candidate is evaluated as a difficult route regardless of the driving operation actually being not so difficult.

It is desirable to provide a technique for objectively evaluating the difficulty level of a target route by taking into consideration various routes each having an attribute similar to that of the target route.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. First Embodiment

### 1-1. System

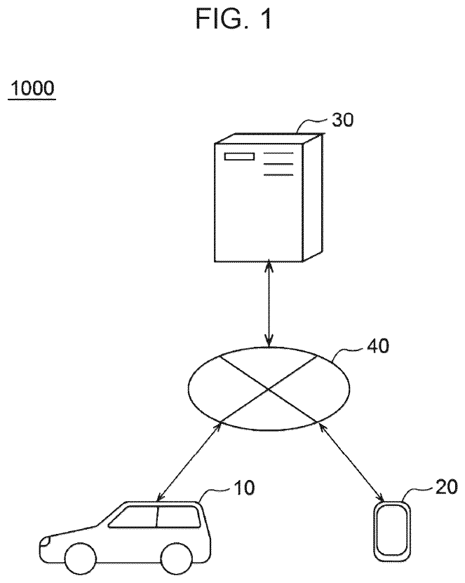

Referring to FIG. 1, a system 1000 includes a vehicle 10, a terminal device 20, and an information processing apparatus 30. The vehicle 10, the terminal device 20, and the information processing apparatus 30 can communicate with one another via a known or any network 40, such as the Internet. In the present disclosure, the terminal device 20 is not an essential component and may be omitted as appropriate.

The vehicle 10 is, for example, an automobile including an internal combustion engine, such as a gasoline engine or a diesel engine. The vehicle 10 is not limited to the above, and may be, for example, an electric vehicle including a driving motor. The electric vehicle may be, for example, a battery electric vehicle (BEV), a hybrid electric vehicle (HEV), a plug-in hybrid electric vehicle (PHEV), or a fuel cell electric vehicle (FCEV).

The terminal device 20 is, for example, a mobile device, such as a smartphone, a mobile phone, a tablet terminal, or a wearable terminal.

The information processing apparatus 30 is a computer, such as a server, belonging to a cloud computing system or another computing system. The present disclosure is not limited to the above, and the information processing apparatus 30 may be installed in the vehicle 10.

### 1-2. Vehicle

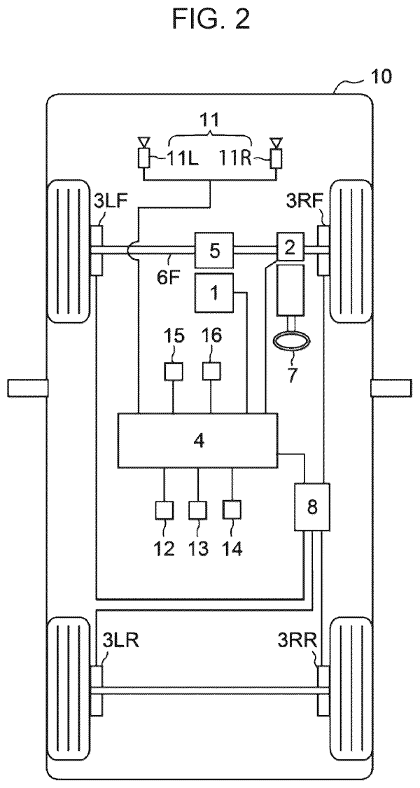

Referring to FIG. 2, the vehicle 10 is configured as a four wheel automobile that transmits a drive torque output from a driving power source 1 to wheels. The combination and driving method of driving wheels are not particularly limited, and the vehicle 10 may be a front-wheel-drive vehicle, a rear-wheel-drive vehicle, or a four-wheel-drive vehicle. In addition, when the vehicle 10 is configured as an electric vehicle, the vehicle 10 may be an electric vehicle including driving motors corresponding to the respective wheels.

The vehicle 10 at least includes, as devices used for driving control, a driving power source 1, an electric steering device 2, brake devices 3LF, 3RF, 3LR, and 3RR (collectively referred to as “brake devices 3” hereinafter when not to be distinguished from one another), and a vehicle control device 4.

The driving power source 1 outputs a drive torque that is transmitted to a front wheel drive shaft 6F via a transmission (not illustrated) and a differential mechanism 5. Driving of the driving power source 1 and the transmission is controlled by the vehicle control device 4.

The electric steering device 2 is provided at the front wheel drive shaft 6F. The electric steering device 2 includes an electric motor (not illustrated) and a gear mechanism (not illustrated), and adjusts the steering angle of the front wheels by being controlled by the vehicle control device 4. The vehicle control device 4 controls the electric steering device 2 based on the steering angle of a steering wheel 7 by a driver. If the vehicle 10 is configured to be capable of executing automatic driving control, the vehicle control device 4 controls the electric steering device 2 based on the steering angle of the steering wheel 7 by the driver during manual driving. On the other hand, during automatic driving, the vehicle control device 4 controls the electric steering device 2 based on a steering angle or a steering angular velocity appropriately set by a known or any automatic driving technique.

The brake devices 3LF, 3RF, 3LR, and 3RR apply braking forces to the respective wheels. The brake devices 3 may be, for example, hydraulic brake devices. In this case, hydraulic pressure to be supplied to each of the brake devices 3 is adjusted by controlling the driving of a hydraulic unit 8 by the vehicle control device 4. When the vehicle 10 is configured as an electric vehicle, the brake devices 3 are used in combination with regenerative braking by the driving motors.

The vehicle control device 4 at least includes one or more electronic control units (ECUs) that control driving of the driving power source 1, the electric steering device 2, and the brake devices 3. The vehicle control device 4 includes one or more ECUs that control driving of various devices installed in the vehicle 10 other than the driving power source 1, the electric steering device 2, and the brake devices 3. The vehicle control device 4 may be provided separately for each control target, as appropriate.

In addition, the vehicle 10 includes a surrounding environment sensor 11, a vehicle state sensor 12, a position detection sensor 13, a communication device 14, a navigation device 15, and a notification device 16.

The surrounding environment sensor 11 at least includes front imaging cameras 11L and 11R. The front imaging cameras 11L and 11R capture images in front of the vehicle 10 and generate image data. Each of the front imaging cameras 11L and 11R includes an imaging device, such as a charge coupled device (CCD) or a complementary metal oxide semiconductor (CMOS), and transmits generated image data to the information processing apparatus 30 via the communication device 14. In FIG. 2, the front imaging cameras 11L and 11R are stereo cameras including a pair of left and right cameras, but may be monocular cameras. Further, the surrounding environment sensor 11 may include a rear imaging camera in addition to the front imaging cameras 11L and 11R. In addition, the surrounding environment sensor 11 may include any one or more ranging sensors selected from a radar sensor, such as a light detection and ranging (LiDAR) or a millimeter wave radar, and an ultrasonic sensor.

The vehicle state sensor 12 includes at least one sensor that detects a state of the vehicle 10 resulting from a driving operation of the vehicle 10 driven by the driver. The vehicle state sensor 12 may include, for example, an accelerator position sensor, a brake stroke sensor, or a steering angle sensor. Further, the vehicle state sensor 12 may include, for example, a vehicle speed sensor, an acceleration sensor, or an angular velocity sensor. The vehicle state sensor 12 transmits a detection result to the information processing apparatus 30 via the communication device 14.

The position detection sensor 13 may include a global navigation satellite system (GNSS) sensor. The GNSS sensor receives a satellite signal from a positioning satellite, such as a global positioning system (GPS) satellite. The position detection sensor 13 transmits positional informational of the vehicle 10 included in the received satellite signal to the information processing apparatus 30 via the communication device 14. The position detection sensor 13 may include, in addition to a GPS sensor, an antenna that receives a satellite signal from another satellite system that identifies the position of the vehicle 10.

The communication device 14 includes at least one communication interface. As the communication interface, for example, an interface compatible with a mobile communication standard, such as 4G (4th Generation) standard or 5G (5th Generation) standard, or a local area network (LAN) standard may be used. The communication device 14 transmits detection results of the surrounding environment sensor 11, the vehicle state sensor 12, and the position detection sensor 13 to the information processing apparatus 30 via the network 40. Further, the communication device 14 receives various kinds of information necessary for controlling the vehicle 10 from the information processing apparatus 30 via the network 40.

The navigation device 15 searches for a guidance route for navigating the vehicle 10 from the current location to the destination based on map information. The navigation device 15 includes a display unit, such as a liquid crystal display (LCD) or an organic electro-luminescence (EL) display, and can output various kinds of information to the driver. Further, the navigation device 15 includes an operation unit, such as a button or a touch panel, and can receive an input operation of the driver.

The notification device 16 notifies the driver of the vehicle 10 of various kinds of information by image display, text display, audio output, or the like. The notification device 16 may be provided integrally with the navigation device 15, may be provided integrally with a meter panel, or may be a head up display (HUD) that performs display on a front window of the vehicle 10.

### 1-3. Information Processing Apparatus

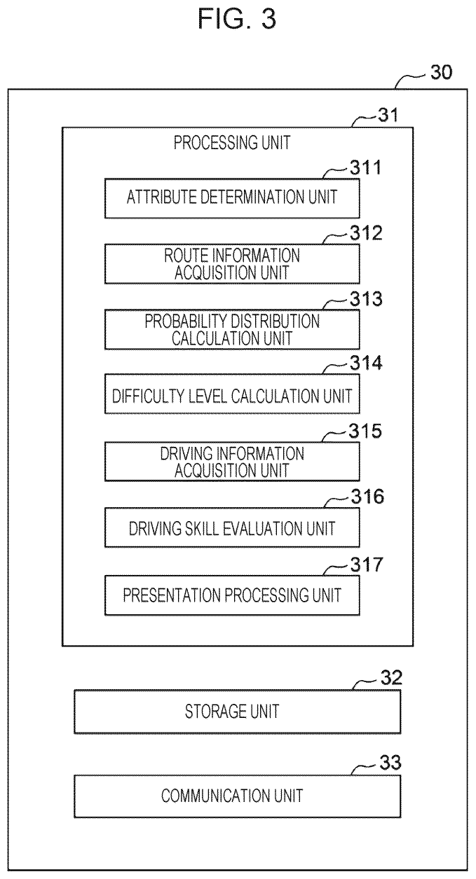

The information processing apparatus 30 according to the first embodiment will now be described in detail with reference to FIG. 3.

### 1-3-1. Configuration Example

The information processing apparatus 30 functions as an apparatus that calculates the difficulty level of a predetermined route by causing one or more processors, such as a central processing unit (CPU), to execute a computer program. The computer program is for causing the processor to execute an operation, which will be described later, to be executed by the information processing apparatus 30. The computer program to be executed by the processor may be recorded on a recording medium functioning as a storage unit (memory) 32 to be described later, or may be recorded on a recording medium contained in the information processing apparatus 30 or any recording medium externally attachable to the information processing apparatus 30.

Examples of the recording medium for recording the computer program may include a magnetic medium such as a hard disk, a floppy disk, and a magnetic tape, an optical recording medium such as a compact disc-read only memory (CD-ROM), a digital versatile disc (DVD), and a Blu-ray Disc (registered trademark), a magneto-optical medium such as a floptical disk, a memory device such as a random access memory (RAM) and a read only memory (ROM), a flash memory such as a universal serial bus (USB) memory and a solid state drive (SSD), and any of other media capable of storing programs.

The information processing apparatus 30 at least includes a processing unit 31, a storage unit 32, and a communication unit 33.

The processing unit 31 includes one or more processors, such as a CPU, and various peripheral components. The processing unit 31 may partially or entirely be configured by updatable firmware or the like, or may be a program module or the like executed by a command from the CPU or the like.

The storage unit 32 is configured by at least one storage element, such as a RAM or a ROM, communicably coupled to the processing unit 31. However, the storage unit 32 is not particularly limited in type and number. The storage unit 32 stores information, such as a computer program executed by the processing unit 31, various parameters used for arithmetic processing, detection data, and an arithmetic result.

The communication unit 33 includes at least one communication interface communicably coupled to the processing unit 31. The communication interface may be an interface compatible with a mobile communication standard, such as 4G standard or 5G standard, or a LAN standard. The communication unit 33 can communicate with each of the vehicle 10 and the terminal device 20 via the network 40. If the information processing apparatus 30 is installed in the vehicle 10, the function of the communication unit 33 may partially or entirely be incorporated in the communication device 14 of the vehicle 10.

### 1-3-2. Functional Configuration of Processing Unit

A functional configuration of the processing unit 31 of the information processing apparatus 30 will now be described. The processing unit 31 includes an attribute determination unit 311, a route information acquisition unit 312, a probability distribution calculation unit 313, a difficulty level calculation unit 314, a driving information acquisition unit 315, a driving skill evaluation unit 316, and a presentation processing unit 317. These units are functions implemented by execution of the computer program by the at least one processor such as a CPU. However, these units may partially or entirely be configured using analog circuits.

### Attribute Determination Unit

The attribute determination unit 311 determines an attribute of a predetermined route R₀. For example, the storage unit 32 may store information about various routes including the predetermined route R₀ and information about the attributes of the respective routes in association with each other in advance. The attribute determination unit 311 may refer to the storage unit 32 to identify the predetermined route R₀ from among the various routes and identify an attribute associated with the identified route, so as to determine the attribute of the predetermined route R₀. The information about the route (hereinafter, abbreviated as “route information”) may include any information for identifying the position of the route on the map. Although examples of the information include the latitude, longitude, and altitude of the route, the present disclosure is not limited thereto, and the information may be, for example, satellite image data including the route. The information about the attribute may include information about one or more of attributes among an attribute indicating whether the area is an urban area, an attribute indicating whether the area is a mountainous area, and an attribute indicating whether the area is a highway.

However, the attribute used in the present disclosure is not limited to the above-described attribute, and may be any attribute that can be set based on the region, type, design speed, or the like of the road. For example, the attribute determination unit 311 may determine whether the attribute of the predetermined route R₀ is a highway or a limited-access road. When the attribute determination unit 311 determines that the attribute of the predetermined route R₀ is a highway or a limited-access road, the attribute determination unit 311 may further determine whether the attribute of the predetermined route R₀ is a mountainous area or a flatland area. If the attribute determination unit 311 determines that the attribute of the predetermined route R₀ is not a highway or a limited-access road, the attribute determination unit 311 may further determine whether the attribute of the predetermined route R₀ is a national road, a prefectural road, or a city road, and may further determine whether the area is a mountain area or a flatland area.

### Route Information Acquisition Unit

The route information acquisition unit 312 acquires information about a plurality of routes Rᵢ (where i is a natural number and an index for identifying each route) each having an attribute similar to the attribute of the predetermined route R₀ determined by the attribute determination unit 311. For example, the route information acquisition unit 312 refers to the storage unit 32 to identify the information about the plurality of routes Rᵢ each having the attribute similar to the attribute of the predetermined route R₀ determined by the attribute determination unit 311. Thus, the plurality of routes Rᵢ similar to the predetermined route R₀ are selected. For example, when the predetermined route R₀ mainly passes through an urban area, a plurality of routes Rᵢ mainly passing through the urban area are selected. When the predetermined route R₀ mainly passes through a mountainous area, a plurality of routes Rᵢ mainly passing through the mountainous area are selected. When the predetermined route R₀ is mainly a highway, a plurality of routes Rᵢ that are mainly highways are selected. For example, the plurality of routes Rᵢ each having the attribute similar to the attribute of the predetermined route R₀ may each be a route in which the distance of a section corresponding to a specific attribute in the predetermined route R₀ and the distance of a section corresponding to the specific attribute in the route Rᵢ match by a certain value or more.

### Probability Distribution Calculation Unit

The probability distribution calculation unit 313 calculates a value indicated by one or more first indicators related to a geographical feature based on the information about the plurality of routes Rᵢ acquired by the route information acquisition unit 312. In addition, the probability distribution calculation unit 313 calculates a first probability distribution indicating the occurrence tendency of the value indicated by the one or more first indicators in all of the plurality of routes Rᵢ acquired by the route information acquisition unit 312.

The first indicator related to the geographical feature is any indicator that reflects the geographical feature of the road and that affects the driving operation, such as the accelerator operation, the brake operation, or the steering operation, by the driver driving the vehicle 10. For example, an example of the first indicator is an indicator related to a road shape, such as a road gradient, curve shape, or road width at a predetermined point Pᵢ or in a predetermined section Sᵢ included in each of the plurality of routes Rᵢ. Here, i is a natural number and is an index for specifying each point or each section. The predetermined point Pᵢ may be any point sequentially selected from a plurality of points set at a predetermined interval from the start point to the end point of each route. The predetermined section Sᵢ may be a section between any two adjacent points sequentially selected from the plurality of points set as described above.

Examples of the first indicator related to the road shape include one or more indicators among a longitudinal gradient, transverse gradient, curvature, curvature change, curve length, road width, curve direction, visual distance, and curve continuity of the road. A longitudinal gradient is an altitude change in the traveling direction of the road, and can be calculated using the latitude, longitude, and altitude of the road. The longitudinal gradient affects the forward visibility from the vehicle 10 and affects a change in the vehicle speed of the vehicle 10 due to inertia. A transverse gradient is an altitude change in the width direction of the road, and can be calculated using the latitude, longitude, and altitude of the road. The transverse gradient affects the bending difficulty of the vehicle 10. A curvature can be calculated using the latitude and longitude of the road, and affects the bending difficulty of the vehicle 10 in a high-speed region. A curvature change can be calculated using the latitude and longitude of the road, and affects an increase or decrease in the driving operation amount of the driver. A curve length can be calculated using the latitude and longitude of the road, and affects the driving operation time of the driver. A curve direction can be calculated using the latitude and longitude of the road, and affects the forward visibility from the vehicle 10 as well as the response to an oncoming vehicle. Although the road width can be calculated using the latitude and longitude of the road, a satellite image may be used, or a road database used in a navigation system may be used. The road width affects the degree of margin for a driving operation error by the driver. A visual distance can be calculated by using the longitude and latitude of the road, a satellite image, and a road database, and affects the forward visibility from the vehicle 10 due to an obstacle such as a tree or a guardrail. It should be noted that a visual distance can be appropriately calculated using a tangent line or the like drawn from the center of the road to the obstacle. Curve continuity can be calculated using the longitude and latitude of the road, may be the distance between curves, or may be a combination of the above-described indicators.

Map information at least including each route of the plurality of routes Rᵢ is stored in advance in the storage unit 32. The probability distribution calculation unit 313 may acquire the map information from the storage unit 32 for each of the plurality of routes Rᵢ, and may calculate the value indicated by the one or more first indicators based on the road shape in the route Rᵢ specified by the acquired map information. Further, the probability distribution calculation unit 313 may calculate, for each of the one or more first indicators, a first probability distribution indicating the occurrence tendency of the value indicated by the one or more first indicators calculated in this manner in all of the plurality of routes Rᵢ.

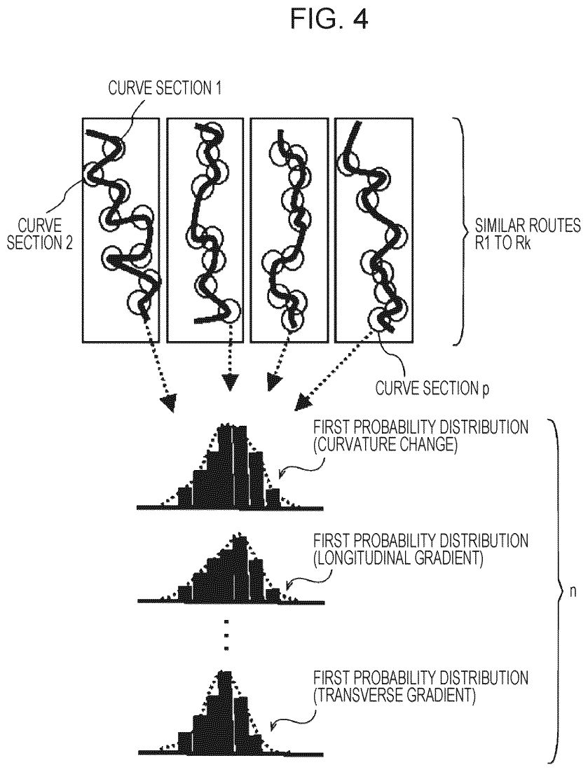

Referring to FIG. 4, the calculation of the first probability distribution will be described in detail with reference to an example where the number of routes Rᵢ each having the attribute similar to the attribute of the predetermined route R₀ is k in total, the number of curve sections in the k routes Rᵢ is p in total, and the number of first indicators is n in total. In this case, the probability distribution calculation unit 313 may calculate the first probability distribution by calculating a probability density function for each of the n first indicators from the road shapes in the total of p curve sections included in the k routes Rᵢ (1≤i≤k) by, for example, a maximum likelihood estimation method. Hereinafter, the maximum likelihood estimation method will be described in detail using a curvature change Cₑ as an example.

First, the probability distribution calculation unit 313 calculates a curvature eᵢ at a point Pᵢ, a curve length d_{i,i+1} of a section Sᵢ (i.e., a section between points Pᵢ and Pᵢ+1), and a curvature change rate in the section Sᵢ obtained by dividing a difference (absolute value) between eᵢ₊₁ and eᵢ by d_{i,i+1}. When calculating the curvature eᵢ, the curve length d_{i,i+1}, and the curvature change rate, the probability distribution calculation unit 313 uses the map information stored in the storage unit 32 to convert the latitudes and longitudes of each route into those in a planar orthogonal coordinate system. Here, the radius of a circle fitted to three points of continuous data is the radius of curvature, and the reciprocal thereof is the curvature. A curvature change rate is a curvature change per unit length, and is a value obtained by dividing the curvature change by the curve length.

Next, the probability distribution calculation unit 313 calculates a curvature change Cₑ defined by Expression (1) below by using the curvature eᵢ, the curve length d_{i,i+1}, and the curvature change rate mentioned above. It should be noted that the accelerator operation, the brake operation, and the steering operation by the driver tend to become more difficult as the curve length becomes longer, the curvature radius becomes smaller, and the curvature change rate becomes larger, and the curvature change Cₑ defined by Expression (1) below reflects these tendencies.

$${C}_{e , p} = \frac{1}{\vert {log}_{10} [ {\sum }_{i = 0}^{k} {e}_{{i}^{′}} \frac{\vert {e}_{i + 1} - {e}_{i} \vert}{{d}_{i , i + 1}} \vert} \qquad ( 1 )$$

It is apparent from Expression (1) above that a perfect simple curve having an antilogarithm of 0 is excluded, and that a special case, such as a spiral curve having a denominator of 1 or less, is excluded.

The probability distribution calculation unit 313 calculates the curvature change Cₑ defined by Expression (1) above for all of the total of p curve sections included in the k routes Rᵢ (1≤i≤k), and stores the curvature change Cₑ in the storage unit 32. That is, the population of the curvature change Cₑ calculated by the probability distribution calculation unit 313 is a group of data (so-called big data) in which information of all curve sections included in the k routes Rᵢ (1≤i≤k) each having an attribute similar to the attribute of the predetermined route R₀ is reflected.

Next, the probability distribution calculation unit 313 collects the population of the curvature change Cₑ by referring to the storage unit 32, and calculates a parameter of a probability density function by a maximum likelihood estimation method, assuming that the collected population accords with a predetermined probability distribution. The predetermined probability distribution is not particularly limited, and may be a normal distribution, a standard normal distribution, a β distribution, a γ distribution, or the like, and can be appropriately selected in accordance with the characteristics of the data. Expressions (2) to (5) below each indicate an example of the maximum likelihood estimation method of parameters α and β in the β distribution on the assumption that the population of the curvature change Cₑ accords with the β distribution.

$$f ( {C}_{e} \vert α , β ) = \frac{{{C}_{e}^{α - 1} ( 1 - {C}_{e} )}^{β - 1}}{B ( α , β )} = \frac{Γ ( α + β )}{Γ ( α ) Γ ( β )} {{C}_{e}^{α - 1} ( 1 - {C}_{e} )}^{β - 1} \qquad ( 2 )$$

$$L ( α , β \vert \{ {C}_{e , 1} , {C}_{e , 2} , … {C}_{e , p} \} ) = \frac{1}{B ( α , β )} {\prod }_{i = 1}^{p} {{C}_{e , p}^{α - 1} ( 1 - {C}_{e} )}^{β - 1} \qquad ( 3 )$$

$$log L ( α , β \vert \{ {C}_{e , 1} , {C}_{e , 2} , … {C}_{e , p} \} ) = ( α - 1 ) {\sum }_{i = 1}^{p} log {C}_{e , p} + ( β - 1 ) {\sum }_{i = 1}^{p} log ( 1 - {C}_{e , p} ) - p log B ( α + β ) \qquad ( 4 )$$

$$maximize log L ( α , β \vert \{ {C}_{e , 1} , {C}_{e , 2} , … {C}_{e , p} \} ) \qquad ( 5 )$$

In Expressions (2) to (5), α and β are shape parameters in the β distribution. Expression (2) above is a probability density function of the curvature change Cₑ conditioned on a and β. Expression (3) above is a likelihood function conditioned on observation data of the curvature change Cₑ. Expression (4) above is a log likelihood function.

### Difficulty Level Calculation Unit

The difficulty level calculation unit 314 calculates the difficulty level of the predetermined route R₀ based on the position, in the first probability distribution, of the value indicated by the one or more first indicators at the predetermined point Pᵢ or in the predetermined section Sᵢ included in the predetermined route R₀. The predetermined point Pᵢ may include a plurality of points sequentially set at a predetermined interval from the start point to the end point of the predetermined route R₀. The predetermined section Sᵢ may be a section between two adjacent points among the plurality of points.

For example, the difficulty level calculation unit 314 may calculate, for each of the n first indicators illustrated in FIG. 4, a mean μ and a standard deviation σ of the population of the first indicator from an estimation parameter in the maximum likelihood estimation method used to calculate the first probability distribution from the information about the total of p curve sections included in the k routes Rᵢ (1≤i≤k). For example, in the case of the curvature change Cₑ included in the first indicator, the difficulty level calculation unit 314 may calculate a mean μ defined by Expression (6) below and a standard deviation σ defined by Expression (7) below, which are obtained from the estimation parameter defined by Expression (5) above.

$$μ = \frac{α}{a + β} \qquad ( 6 )$$

$$σ = \sqrt{\frac{α β}{{( α + β )}^{2} ( α + β + 1 )}} \qquad ( 7 )$$

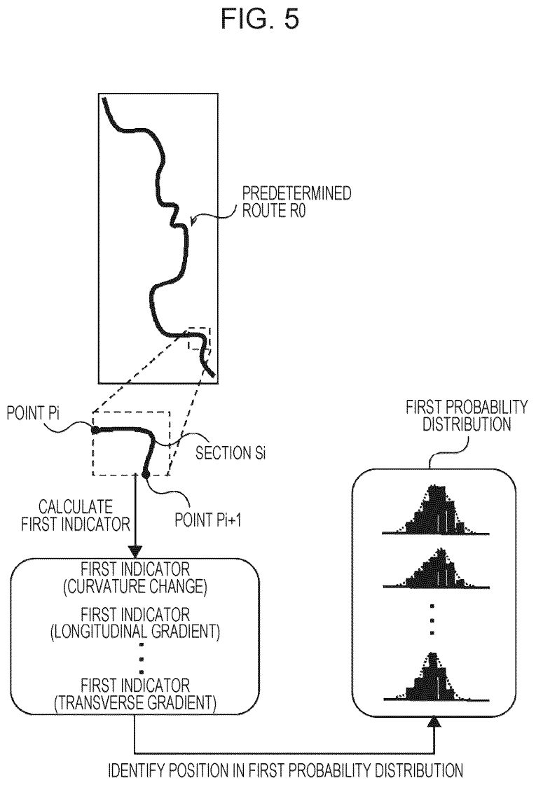

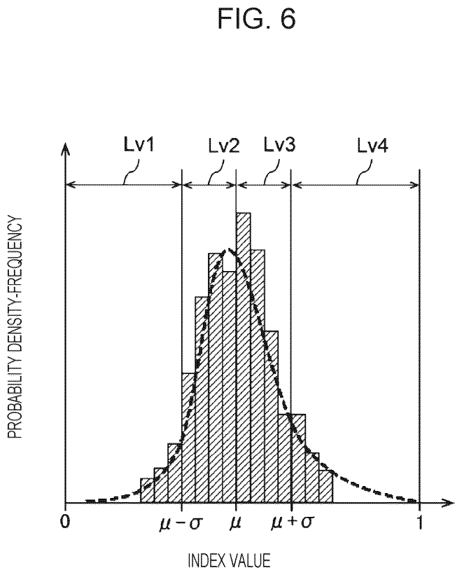

On the other hand, for each of the one or more first indicators, the difficulty level calculation unit 314 may calculate a value indicated by the first indicator for each point Pᵢ or each section Sᵢ included in the predetermined route R₀. Note that “i” in “Pᵢ” or “Sᵢ” is an index for specifying each point or each section from the start point to the end point, and sequentially changes from the start point to the end point. Then, the difficulty level calculation unit 314 may calculate the difficulty level of the predetermined route R₀ for each point Pᵢ or each section Sᵢ based on the position of the value indicated by the calculated first indicator in the population of the first indicator. For example, the difficulty level calculation unit 314 acquires the map information including the predetermined route R₀ illustrated in FIG. 5 by referring to the storage unit 32. The difficulty level calculation unit 314 may calculate the values indicated by the n first indicators for each point Pᵢ or each section Sᵢ based on the road shape at the point Pᵢ or the section Sᵢ included in the predetermined route R₀ specified by the acquired map information. For each of the n first indicators for each point Pᵢ or each section Sᵢ, the difficulty level calculation unit 314 may calculate the difficulty level of the predetermined route R₀ for each point Pᵢ or each section Sᵢ based on the degree of deviation of the value indicated by the first indicator from the mean μ and the standard deviation σ of the population of the first indicator. As will be described in more detail later with reference to FIG. 6, the position in the first probability distribution for each of the n first indicators is identified using the degree of deviation. The present disclosure is not limited to a calculation of the difficulty level in view of a curve section as illustrated in FIG. 5, and may include a calculation of the difficulty level in view of a straight section.

In the example illustrated in FIG. 6, 0 or more and less than (mean μ−standard deviation σ) is classified into level 1 (Lv1), (mean μ−standard deviation σ) or more and less than the mean μ is classified into level 2 (Lv2), the mean μ or more and less than (mean μ+standard deviation σ) is classified into level 3 (Lv3), and (mean μ+standard deviation σ) or more and 1 or less is classified into level 4 (Lv4). Here, the difficulty level increases as the level increases. In this way, the difficulty level calculation unit 314 can calculate the difficulty level of the predetermined route R₀ based on where each of the n first indicators is located in the corresponding population for each point Pᵢ or each section Sᵢ included in the predetermined route R₀. For example, when the occurrence frequency of the value of the curvature change Cₑ is high in the predetermined route R₀ regardless of the value of the curvature change Cₑ being large enough to hardly occur in general, the predetermined route R₀ is a route with a high difficulty level.

Note that the difficulty level calculation unit 314 may calculate the difficulty level of the entire predetermined route R₀ by integrating difficulty levels at the point Pᵢ or the section Sᵢ included in the predetermined route R₀ from the start point to the end point of the predetermined route R₀. For example, as the difficulty level of the entire predetermined route R₀, curvature change levels, visibility levels, or curve continuity levels may be calculated, and the overall difficulty level may be calculated by integrating these levels.

### Driving Information Acquisition Unit

The driving information acquisition unit 315 acquires information about a driving operation performed by the driver driving the vehicle 10 at the predetermined point Pᵢ or in the predetermined section Sᵢ included in the predetermined route R₀. For example, the driving information acquisition unit 315 acquires detection results of the vehicle state sensor 12 and the position detection sensor 13 of the vehicle 10 from the vehicle 10 via the communication unit 33 every time a predetermined time (e.g., a calculation cycle of various sensors) elapses after the vehicle 10 is started.

The information about the driving operation may include an acceleration/deceleration adjustment operation or a correction operation of steering of the vehicle 10 by the driver, and may be stored in the storage unit 32 together with positional information of the vehicle 10 at a time point when the driving operation is performed by the driver. The “correction operation” refers to turning the steering wheel from one direction to the other direction and then turning the steering wheel from the other direction to the one direction within a predetermined time. The acceleration/deceleration adjustment operation can be identified by a known or any method from detection values of the vehicle speed sensor and the acceleration sensor included in the vehicle state sensor 12 of the vehicle 10. The steering correction operation can be identified by a known or any method from a detection value of the steering angle sensor included in the vehicle state sensor 12 of the vehicle 10. The position of the vehicle 10 can be identified by a known or any method from a detection value of the position detection sensor 13 of the vehicle 10. The information about the driving operation in the present disclosure is not limited to the above, and may include any information that can be identified by a known or any method from detection values of various sensors included in the vehicle state sensor 12 of the vehicle 10. Further, instead of the detection values of the various sensors included in the vehicle state sensor 12 of the vehicle 10, detection values of various sensors, such as an acceleration sensor, an angular velocity sensor, or a position detection sensor, included in the terminal device 20, such as a smartphone carried by the driver, may be used.

### Driving Skill Evaluation Unit

The driving skill evaluation unit 316 evaluates the driving skill of the driver at the predetermined point Pᵢ or in the predetermined section Sᵢ included in the predetermined route R₀ based on the difficulty level calculated by the difficulty level calculation unit 314 and the information about the driving operation acquired by the driving information acquisition unit 315. For example, the driving skill evaluation unit 316 may evaluate that the driving skill of the driver is low as the number of times the acceleration/deceleration adjustment operation of the vehicle 10 is performed by the driver at the point Pᵢ or in the section Sᵢ is larger than a reference value, regardless of the difficulty level being low at the point Pᵢ or in the section Sᵢ included in the predetermined route R₀. On the other hand, the driving skill evaluation unit 316 may evaluate that the driving skill of the driver is high as the number of times the acceleration/deceleration adjustment operation of the vehicle 10 is performed by the driver at the point Pᵢ or in the section Sᵢ is smaller than the reference value, regardless of the difficulty level being high at the point Pᵢ or in the section Sᵢ included in the predetermined route R₀. The driving skill evaluation unit 316 may evaluate that the driving skill of the driver is low as the number of times the steering correction operation is performed by the driver at the point Pᵢ or in the section Sᵢ increases, regardless of the difficulty level being low at the point Pᵢ or in the section Sᵢ included in the predetermined route R₀. The driving skill evaluation unit 316 may evaluate that the driving skill of the driver is high as the number of times the steering correction operation is performed by the driver at the point Pᵢ or in the section Sᵢ decreases, regardless of the difficulty level being high at the point Pᵢ or in the section Sᵢ included in the predetermined route R₀. The evaluation of the driving skill may be an evaluation using a continuous value, such as a score, but is not limited thereto in the present disclosure, and may be an evaluation using multiple stages, such as a “beginner stage”, “intermediate stage”, and “advanced stage”.

The driving skill evaluation unit 316 may identify a point Pⱼ or a section Sⱼ where the evaluation value of the driving skill is less than a predetermined reference value in a travel route, as an example of the predetermined route R₀, of the vehicle 10 driven by the driver whose driving skill is to be evaluated, and may perform the following process. Here, j is a natural number, and is an index for specifying a point or a section where the evaluation value of the driving skill is less than the predetermined reference value among a plurality of points or sections. That is, the driving skill evaluation unit 316 may identify information about a driving operation by a model driver and identify a difference between the driving operation of the driver and the driving operation of the model driver at the specified point Pⱼ or in the specified section Sⱼ.

For example, the storage unit 32 may store in advance the information about the driving operation of the model driver set according to the difficulty level in the first probability distribution calculated using the information about the plurality of routes Rᵢ each having an attribute similar to an attribute of the travel route of the vehicle 10 driven by the driver. Here, the model driver set according to the difficulty level may refer to a driver having a standard driving skill or an expert-level driving skill for safely driving the vehicle 10 at a point or in a section indicating the relevant difficulty level. In the same manner as the method described above, the driving skill evaluation unit 316 may calculate the difficulty level at the point Pⱼ or in the section Sⱼ based on the position, in the first probability distribution, of the value indicated by the first indicator at the point Pⱼ or in the section Sⱼ where the evaluation value of the driving skill is less than the predetermined reference value. Then, the driving skill evaluation unit 316 may refer to the storage unit 32 to identify the information about the driving operation of the model driver appropriately set in accordance with the calculated difficulty level, thereby identifying the difference between the driving operation of the driver and the driving operation of the model driver. The difference in the driving operation is not particularly limited, and may be, for example, a timing difference between the driving operation by the driver and the driving operation by the model driver, or a trajectory difference of the vehicle 10 between the driver and the model driver.

### Presentation Processing Unit

The presentation processing unit 317 performs a process of presenting, to the driver, the difficulty level of the driving operation calculated by the difficulty level calculation unit 314 and the driving operation by the driver acquired by the driving information acquisition unit 315 in association with each other at the predetermined point Pᵢ or in the predetermined section Sᵢ included in the travel route, as an example of the predetermined route R₀, of the vehicle 10 driven by the driver whose driving skill is to be evaluated. For example, after the driver finishes driving the vehicle 10, the presentation processing unit 317 may generate feedback information in which the aforementioned difficulty level and driving operation are associated with each other and that can be recognized by the driver via the notification device 16 of the vehicle 10, and may transmit the feedback information to the vehicle 10 via the communication unit 33. The feedback information may include (i) information about the point Pⱼ or the section Sᵢ where the evaluation value of the driving skill is less than the predetermined reference value in the travel route of the vehicle 10 driven by the driver, (ii) the difficulty level at the point Pⱼ or in the section Sᵢ, and (iii) information about the driving operation actually performed by the driver at the point Pⱼ or in the section Sᵢ. Accordingly, as compared with a plurality of similar routes Rᵢ, the driver can objectively ascertain the difficulty level at the point Pⱼ or in the section Sᵢ where the driver is evaluated as having a low driving skill. In addition, the driver can review the driver's driving operation at the point Pⱼ or in the section Sᵢ where the driver is evaluated as having a low driving skill. Therefore, the driver can review the driver's own driving operation while ascertaining not only the correspondence with the map information but also the correspondence with the objective difficulty level in view of various routes similar to the travel route, so that the driving skill can be efficiently improved.

When the difference between the driving operation of the driver and the driving operation of the model driver is identified as described above, the presentation processing unit 317 may perform a process of presenting the identified difference in the driving operation to the driver. In this case, the above-described feedback information may include, for example, information for allowing the driver to recognize a timing difference between the driving operations of the driver and the model driver, a trajectory difference of the vehicle 10, or the like. In addition, the feedback information may include, for example, information for superimposing the timing difference between the driving operation by the driver and the driving operation by the model driver, the trajectory difference of the vehicle 10, or the like on a map including the point Pⱼ or the section Sᵢ as a still image or a moving image (e.g., animation) and allowing the driver to visually recognize the difference via the notification device 16 of the vehicle 10. As a result, the driver can also ascertain the driving operation of the model driver at the point Pⱼ or in the section Sⱼ where the driver is evaluated as having a low driving skill, so that the driving skill can be improved more efficiently.

The presentation processing unit 317 may perform a process of presenting, to the driver, advice information according to the driving style of the driver. The driving style can be identified by the driving skill evaluation unit 316 based on the information about the driving operation of the driver acquired by the driving information acquisition unit 315. For example, whether the driving style is of a safety type, a passive type, or a sports type may be identified based on the vehicle speed, acceleration, jerk, or the like of the vehicle 10. In this case, the above-described feedback information may include any advice information for improving the driving skill of the driver in accordance with the safety type, the passive type, or the sports type.

Instead of the notification device 16 of the vehicle 10, the above-described feedback information may be transmitted to the terminal device 20, such as a smartphone carried by the driver. In this case, the driver can ascertain the feedback information via the display of the terminal device 20.

### 1-3-3. Operation Example of Information Processing Apparatus

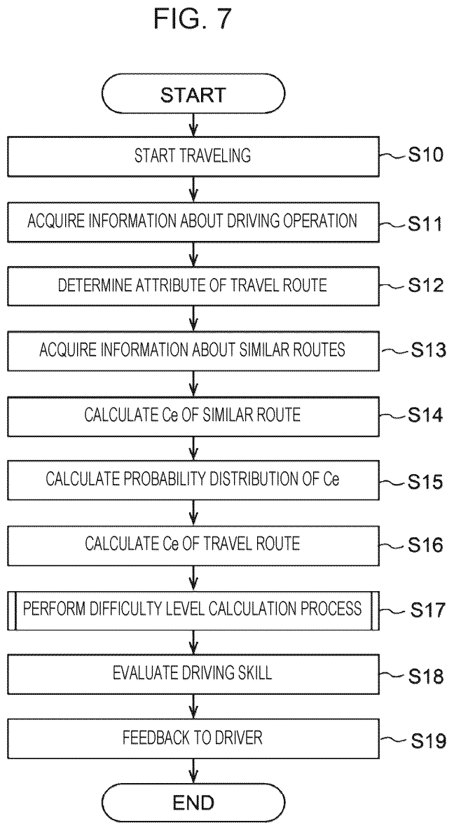

With reference to FIG. 7, an operation example of the information processing apparatus 30 according to the first embodiment will be described along a flowchart.

For the sake of simplicity, the following description relates to an example where the curvature change Cₑ is adopted as the first indicator, and the travel route of the vehicle 10 along the guidance route from the current location to the destination designated by the driver of the vehicle 10 via the navigation device 15 is adopted as the predetermined route R₀. However, the operation example of the information processing apparatus 30 is not limited to the above, and the first indicator to be appropriately adopted may include various first indicators described above instead of the curvature change Cₑ or in addition to the curvature change Cₑ.

In step S10, the vehicle 10 starts traveling along the guidance route from the current location to the destination designated by the driver via the navigation device 15. Subsequently, the process proceeds to step S11.

In step S11, the driving information acquisition unit 315 of the processing unit 31 acquires information about the driving operation by the driver for each point Pᵢ or each section Sᵢ included in the travel route of the vehicle 10 (hereinafter, simply referred to as a “travel route”) corresponding to the predetermined route R₀. Then, the driving information acquisition unit 315 stores the acquired information about the driving operation in the storage unit 32 in association with positional information of the point Pᵢ or the section Sᵢ. Step S11 is performed until the vehicle 10 arrives at the destination after departing from the current location.

In step S12, the attribute determination unit 311 of the processing unit 31 determines the attribute of the travel route based on the above-described method by referring to the storage unit 32. The process then proceeds to step S13.

In step S13, the route information acquisition unit 312 of the processing unit 31 refers to the storage unit 32 to acquire information about k routes Rᵢ (1≤i≤k) each having an attribute similar to the attribute determined in step S12. The process then proceeds to step S14.

In step S14, the probability distribution calculation unit 313 of the processing unit 31 calculates a curvature change Cₑ (hereinafter, simply referred to as a “curvature change Cₑ”) corresponding to the first indicator, based on the information about the k routes Rᵢ (1≤i≤k) acquired in step S13. For example, the probability distribution calculation unit 313 calculates the curvature change Cₑ defined by Expression (1) above for all of the total of p curve sections included in the k routes Rᵢ (1≤i≤k). The process then proceeds to step S15.

In step S15, the probability distribution calculation unit 313 of the processing unit 31 calculates a first probability distribution indicating the occurrence tendency, in all of the k routes Rᵢ (1≤i≤k), of the value indicated by the curvature change Cₑ calculated in step S14. For example, the probability distribution calculation unit 313 calculates the first probability distribution by assuming that the population of the curvature change Cₑ accords with, for example, the β distribution as described above and calculating the parameter of the probability density function based on the maximum likelihood estimation method. The process then proceeds to step S16.

In step S16, the difficulty level calculation unit 314 of the processing unit 31 calculates the curvature change Cₑ for each point Pᵢ or each section Sᵢ included in the travel route based on the above-described method. The process then proceeds to step S17.

In step S17, the difficulty level calculation unit 314 of the processing unit 31 calculates the difficulty level of the travel route for each point Pᵢ or each section Sᵢ based on the position, in the first probability distribution calculated in step S15, of the curvature change Cₑ calculated in step S16. Then, the difficulty level calculation unit 314 stores the calculated difficulty level in the storage unit 32 in association with the information about the point Pᵢ or the section Sᵢ.

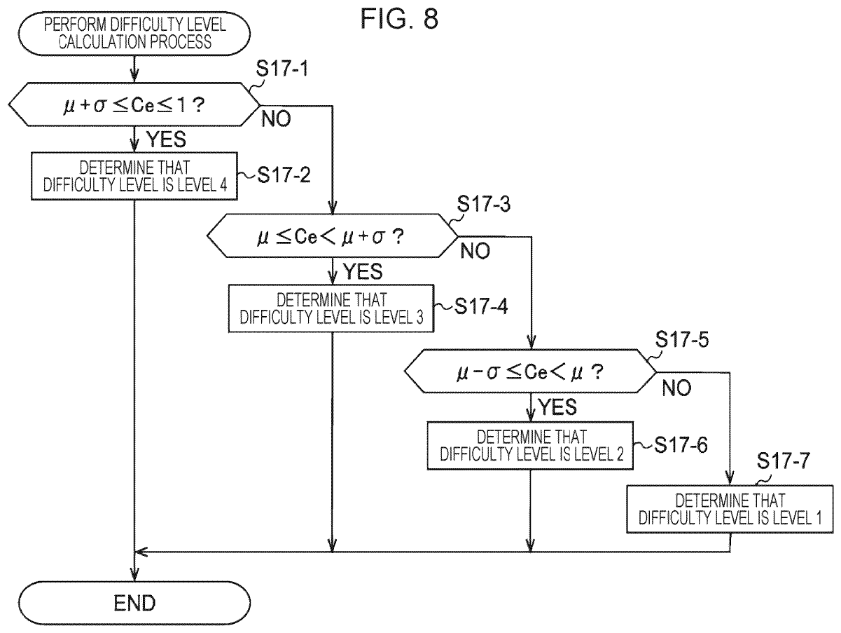

The difficulty level calculation process in step S17 will be described here in detail with reference to FIG. 8. In this operation example, the difficulty level calculation unit 314 of the processing unit 31 calculates the difficulty level of the travel route for each point Pᵢ or each section Sᵢ based on the degree of deviation of the curvature change Cₑ for each point Pᵢ or each section Sᵢ from the mean μ and the standard deviation σ of the population of the curvature change Cₑ. The mean μ and the standard deviation σ of the population of the curvature change Cₑ can be calculated from the estimation parameter in the maximum likelihood estimation method as described above.

For example, in step S17-1, the difficulty level calculation unit 314 of the processing unit 31 determines whether the curvature change Cₑ is greater than or equal to (mean μ+standard deviation σ) and less than or equal to 1. If the curvature change Cₑ is greater than or equal to (mean μ+standard deviation σ) and less than or equal to 1 (YES in step S17-1), the process proceeds to step S17-2. On the other hand, if the curvature change Cₑ is not greater than or equal to (mean μ+standard deviation σ) and not less than or equal to 1 (NO in step S17-1), the process proceeds to step S17-3.

In step S17-2, the difficulty level calculation unit 314 of the processing unit 31 determines that the difficulty level of the travel route at the point Pᵢ or in the section Sᵢ is level 4. Subsequently, the difficulty level calculation process ends, and the process proceeds to step S18 in FIG. 7.

In step S17-3, the difficulty level calculation unit 314 of the processing unit 31 determines whether the curvature change Cₑ is greater than or equal to the mean μ and less than (mean μ+standard deviation σ). If the curvature change Cₑ is greater than or equal to the mean μ and less than (mean μ+standard deviation σ) (YES in step S17-3), the process proceeds to step S17-4. On the other hand, if the curvature change Cₑ is not greater than or equal to the mean μ and not less than (mean μ+standard deviation σ) (NO in step S17-3), the process proceeds to step S17-5.

In step S17-4, the difficulty level calculation unit 314 of the processing unit 31 determines that the difficulty level of the travel route at the point Pᵢ or in the section Sᵢ is level 3. Subsequently, the difficulty level calculation process ends, and the process proceeds to step S18 in FIG. 7.

In step S17-5, the difficulty level calculation unit 314 of the processing unit 31 determines whether the curvature change Cₑ is greater than or equal to (mean μ−standard deviation σ) and less than the mean μ. If the curvature change Cₑ is greater than or equal to (mean μ−standard deviation σ) and less than the mean μ (YES in step S17-5), the process proceeds to step S17-6. On the other hand, if the curvature change Cₑ is not greater than or equal to (mean μ−standard deviation σ) and not less than the mean μ (NO in step S17-5), the process proceeds to step S17-7.

In step S17-6, the difficulty level calculation unit 314 of the processing unit 31 determines that the difficulty level of the travel route at the point Pᵢ or in the section Sᵢ is level 2. Subsequently, the difficulty level calculation process ends, and the process proceeds to step S18 in FIG. 7.

In step S17-7, the difficulty level calculation unit 314 of the processing unit 31 determines that the difficulty level of the travel route at the point Pᵢ or in the section Sᵢ is level 1. Subsequently, the difficulty level calculation process ends, and the process proceeds to step S18 in FIG. 7.

The difficulty level calculation unit 314 of the processing unit 31 may repeat the process from steps S17-1 to S17-7 described above from the start point to the end point of the travel route for each point Pᵢ or each section Sᵢ included in the travel route. Accordingly, the respective difficulty levels of all the curve sections included in the travel route can be comprehensively calculated.

Returning back to FIG. 7, in step S18, the driving skill evaluation unit 316 of the processing unit 31 evaluates the driving skill of the driver for each point Pᵢ or each section Sᵢ included in the travel route based on the difficulty level calculated in step S17 and the information about the driving operation acquired in step S11. As described above, the driving skill evaluation unit 316 may identify the difference between the driving operation of the driver and the driving operation of the model driver at the point Pⱼ or in the section Sⱼ where the evaluation value of the driving skill is less than the predetermined reference value. The process then proceeds to step S19.

In step S19, the presentation processing unit 317 of the processing unit 31 performs a process of feeding back the evaluation result of the driving skill obtained in step S18 to the driver. Note that, as described above, the presentation processing unit 317 may use, for example, a still image or a moving image (e.g., animation) to feed back, to the driver, the difference between the driving operation of the driver and the driving operation of the model driver at the point Pⱼ or the section Sⱼ where the evaluation value of the driving skill is less than the predetermined reference value. Subsequently, the process ends.

### 1-4. Conclusion

As described above, the information processing apparatus 30 according to the first embodiment calculates the difficulty level of a predetermined route R₀. In particular, the processing unit 31 of the information processing apparatus 30 determines the attribute of the predetermined route R₀. Then, the processing unit 31 acquires information about a plurality of routes Rᵢ each having an attribute similar to the determined attribute. Subsequently, based on the acquired information about the plurality of routes Rᵢ, the processing unit 31 calculates a first probability distribution indicating the occurrence tendency of a value indicated by one or more first indicators related to a geographical feature in all of the plurality of routes Rᵢ. Then, the processing unit 31 calculates the difficulty level of the predetermined route R₀ based on the position, in the first probability distribution, of the value indicated by the one or more first indicators at a point Pᵢ or in a section Sᵢ included in the predetermined route R₀.

According to such a configuration, since the population of the first indicator related to the geographical feature in the plurality of routes Rᵢ each having the attribute similar to that of the predetermined route R₀ is taken into consideration, the difficulty level of the predetermined route R₀ can be calculated objectively. As a result, for example, even when the difficulty level of the predetermined route R₀ alone is high, the difficulty level of the predetermined route R₀ is calculated to be low if the difficulty level of all of the routes Rᵢ each having the attribute similar to that of the predetermined route R₀ is low. Therefore, the difficulty level of the target route can be evaluated objectively by taking into consideration various routes each having an attribute similar to that of the target route. As a result, the driving skill of the driver can be objectively evaluated by using such a difficulty level for the evaluation of the driving skill of the driver.

### 2. Second Embodiment

An information processing apparatus 30 according to a second embodiment of the present disclosure will now be described. The following description of the information processing apparatus 30 according to this embodiment focuses on differences from the first embodiment.

### 2-1. Configuration Example of Information Processing Apparatus Probability Distribution Calculation Unit

The probability distribution calculation unit 313 calculates a value indicated by one or more second indicators related to the road surface condition based on information about the plurality of routes Rᵢ each having an attribute similar to the attribute of the predetermined route R₀ determined by the attribute determination unit 311 in the same manner as in the first embodiment. A second indicator is any indicator that reflects the road surface condition and affects the driving operation, such as the accelerator operation, the brake operation, or the steering operation, by the driver. A value indicated by a second indicator may be a value related to the shape of the road surface, such as the degree of unevenness of the road surface or the degree of rutting, at a predetermined point Pᵢ or in a predetermined section Sᵢ included in each of the plurality of routes Rᵢ. The probability distribution calculation unit 313 can calculate the value indicated by the second indicator by performing known or any image recognition processing on image data, captured by the surrounding environment sensor 11 of the vehicle 10 or another vehicle and stored in the storage unit 32 in advance, or on satellite image data.

The probability distribution calculation unit 313 calculates a second probability distribution indicating the occurrence tendency of the value indicated by the one or more second indicators calculated based on the above-described method in all of the plurality of routes Rᵢ acquired by the route information acquisition unit 312. For example, as in the first embodiment, the probability distribution calculation unit 313 may calculate the second probability distribution by calculating a probability density function for each of m second indicators (m may be equal to n) from the shapes of the road surfaces in the k routes Rᵢ (1≤i≤k) based on the same method as that for the first indicators. For example, when a degree D_{w} of rutting is included in a second indicator, the probability distribution calculation unit 313 calculates a second probability distribution that accords with a population of the degree D_{w} of rutting corresponding to a data group in which information about the degree D_{w} of rutting in the k routes R_{I} (1≤i≤k) each having an attribute similar to the attribute of the predetermined route R₀ is reflected.

### Difficulty Level Calculation Unit

The difficulty level calculation unit 314 calculates the difficulty level at the predetermined point Pᵢ or in the predetermined section Sᵢ included in the predetermined route R₀ based on (i) the position, in the first probability distribution, of the value indicated by one or more first indicators at the predetermined point Pᵢ or in the predetermined section Sᵢ included in the predetermined route R₀ and (ii) the position, in the second probability distribution, of the value indicated by one or more second indicators at the predetermined point Pᵢ or in the predetermined section Sᵢ included in the predetermined route R₀.

For example, regarding each first indicator, the difficulty level calculation unit 314 may calculate, for each of the n first indicators at the point Pᵢ or in the section Sᵢ included in the predetermined route R₀, a degree of deviation (hereinafter, may be referred to as “first degree of deviation”) of the value indicated by the first indicator from the mean μ and the standard deviation σ of the population of the first indicator in the same manner as in the first embodiment.

On the other hand, regarding each second indicator, the difficulty level calculation unit 314 may calculate the value indicated by each of the m second indicators at the point Pᵢ or in the section Sᵢ based on the road surface condition at the point Pᵢ or in the section Sᵢ included in the predetermined route R₀. The difficulty level calculation unit 314 may perform known or any image recognition processing on the image data captured by the surrounding environment sensor 11 of the vehicle 10 and calculate the value indicated by the second indicator every time a predetermined time (e.g., a calculation cycle of various sensors) elapses after the vehicle 10 is started. Additionally or alternatively, the difficulty level calculation unit 314 may calculate the value indicated by the second indicator from the acceleration and the angular velocity of the vehicle 10 included in the detection result of the vehicle state sensor 12 of the vehicle 10 every time a predetermined time elapses after the vehicle 10 is started. Further, when calculating the value indicated by the second indicator, the difficulty level calculation unit 314 may use satellite image data or the like, stored in the storage unit 32 in advance, in a supplementary manner. However, the present disclosure is not limited to the above, and instead of detection values of various sensors included in the surrounding environment sensor 11 or the vehicle state sensor 12 of the vehicle 10, detection values of various sensors included in the terminal device 20, such as a smartphone carried by the driver, may be used. The difficulty level calculation unit 314 may calculate, for each of the m second indicators at the point Pᵢ or in the section Sᵢ, a degree of deviation (hereinafter, may be referred to as a “second degree of deviation”) of the value indicated by the second indicator from the mean μ and the standard deviation σ of the population of the second indicator. For calculating the second degree of deviation, the difficulty level calculation unit 314 can appropriately use the estimation parameter in the maximum likelihood estimation method used when calculating the second probability distribution, as in the first embodiment.

As described above, the difficulty level calculation unit 314 may calculate n first degrees of deviation with respect to n first indicators and m second degrees of deviation with respect to m second indicators for each point Pᵢ or each section Sᵢ included in the predetermined route R₀.

The difficulty level calculation unit 314 may calculate the difficulty level for each point Pᵢ or each section Sᵢ included in the predetermined route R₀ by integrating the n first degrees of deviation and the m second degrees of deviation for each point Pᵢ or each section Sᵢ included in the predetermined route R₀. For example, for each of the n first indicators and the m second indicators, 0 or more and less than (mean μ−standard deviation σ) may be classified into level 1, (mean μ−standard deviation σ) or more and less than the mean μ may be classified into level 2, the mean μ or more and less than (mean μ+standard deviation σ) may be classified into level 3, and (mean μ+standard deviation σ) or more and 1 or less may be classified into level 4. In this case, the difficulty level calculation unit 314 may calculate the difficulty level for each point Pᵢ or each section Sᵢ by performing arithmetic-averaging, weighted-averaging, or the like on the levels of the n first indicators and the levels of the m second indicators. However, the present disclosure is not limited to the above, and the difficulty level calculation unit 314 may calculate the difficulty level for each point Pᵢ or each section Sᵢ by further subdividing the level of each of the n first indicators using the level of each of the m second indicators.

### Driving Skill Evaluation Unit

The driving skill evaluation unit 316 evaluates the driving skill of the driver at the point Pᵢ or the section Sᵢ included in the predetermined route R₀ based on the difficulty level calculated by the difficulty level calculation unit 314 and information about the driving operation acquired by the driving information acquisition unit 315, as in the first embodiment.

### 2-2. Operation Example of Information Processing Apparatus

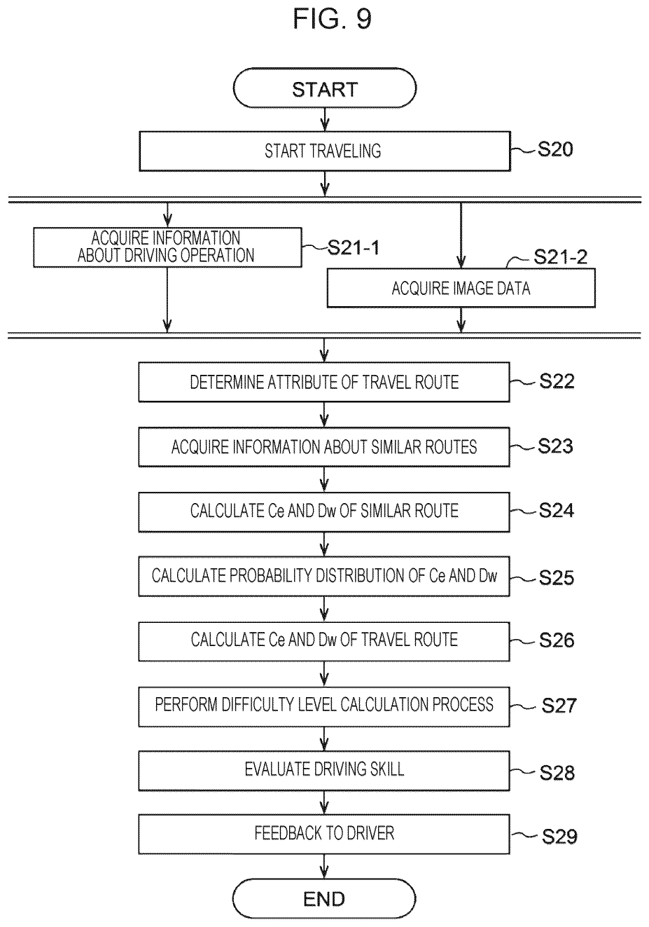

Referring to FIG. 9, an operation example of the information processing apparatus 30 according to the second embodiment will be described along a flowchart.

For the sake of simplicity, the following description relates to an example where the curvature change Cₑ is adopted as the first indicator, the degree D_{w} of rutting is adopted as the second indicator, and the travel route of the vehicle 10 along the guidance route from the current location to the destination designated by the driver of the vehicle 10 via the navigation device 15 is adopted as the predetermined route R₀. However, the operation example of the information processing apparatus 30 is not limited to the above, and the first indicator to be appropriately adopted may include various first indicators described above instead of the curvature change Cₑ or in addition to the curvature change Cₑ, and the second indicator to be appropriately adopted may include various second indicators described above instead of the degree D_{w} of rutting or in addition to the degree D_{w} of rutting.

In step S20, the vehicle 10 starts traveling along the guidance route from the current position to the destination designated by the driver via the navigation device 15. The process then proceeds to steps S21-1 and S21-2. Steps S21-1 and S21-2 are performed concurrently until the vehicle 10 arrives at the destination after departing from the current location.

In step S21-1, the driving information acquisition unit 315 of the processing unit 31 acquires information about the driving operation by the driver for each point Pᵢ or each section Sᵢ included in the travel route of the vehicle 10 (hereinafter, simply referred to as a “travel route”) corresponding to the predetermined route R₀. Then, the driving information acquisition unit 315 stores the acquired information about the driving operation in the storage unit 32 in association with the positional information of the point Pᵢ or the section Sᵢ.

In step S21-2, the difficulty level calculation unit 314 of the processing unit 31 acquires image data captured by the surrounding environment sensor 11 of the vehicle 10 from the vehicle 10 via the communication unit 33 every time a predetermined time elapses after the vehicle 10 starts traveling. Then, the difficulty level calculation unit 314 stores the acquired image data in the storage unit 32 in association with the positional information of the acquired point.

In step S22, the attribute determination unit 311 of the processing unit 31 determines the attribute of the travel route in the same manner as in the first embodiment. The process then proceeds to step S23.

In step S23, the route information acquisition unit 312 of the processing unit 31 acquires information about k routes Rᵢ (1≤i≤k) each having an attribute similar to the attribute determined in step S22, as in the first embodiment. The process then proceeds to step S24.

In step S24, the probability distribution calculation unit 313 of the processing unit 31 calculates the degree D_{w} Of rutting based on the information about the k routes Rᵢ (1≤i≤k) acquired in step S23. For example, the probability distribution calculation unit 313 calculates the degree D_{w} of rutting included in the k routes Rᵢ (1≤i≤k) by performing known or any image recognition processing on image data captured by the surrounding environment sensor 11 of the vehicle 10 or another vehicle and stored in the storage unit 32 in advance or on satellite image data. The probability distribution calculation unit 313 calculates the curvature change Cₑ in the same manner as in the first embodiment. The process then proceeds to step S25.

In step S25, the probability distribution calculation unit 313 of the processing unit 31 calculates a second probability distribution indicating the occurrence tendency of the degree D_{w} of rutting calculated in step S24 in all of the k routes Rᵢ (1≤i≤k). For example, as described above, the probability distribution calculation unit 313 calculates the second probability distribution by calculating a parameter of a probability density function using the maximum likelihood estimation method based on the assumption that the population of the degree D_{w} of rutting accords with, for example, the β distribution. The probability distribution calculation unit 313 also calculates a first probability distribution related to the curvature change Cₑ in the same manner as in the first embodiment. The process then proceeds to step S26.

In step S26, the difficulty level calculation unit 314 of the processing unit 31 performs known or any image recognition processing on the image data acquired in step S21-2, thereby calculating the degree D_{w} of rutting for each point Pᵢ or section Sᵢ included in the travel route. Similar to the first embodiment, the difficulty level calculation unit 314 also calculates the curvature change Cₑ for each point Pᵢ or each section Sᵢ included in the travel route. The process then proceeds to step S27.

In step S27, the difficulty level calculation unit 314 of the processing unit 31 calculates the difficulty level of the travel route for each point Pᵢ or each section Sᵢ based on (i) the position, in the first probability distribution calculated in step S25, of the curvature change Cₑ calculated in step S26 and (ii) the position, in the second probability distribution calculated in step S25, of the degree D_{w} of rutting calculated in step S26. For example, the difficulty level calculation unit 314 determines the level (one of levels 1 to 4) related to the curvature change Cₑ for each point Pᵢ or section Sᵢ included in the travel route by using the mean μ and the standard deviation σ of the population related to the curvature change Cₑ based on the same method as that in the first embodiment. In addition, the difficulty level calculation unit 314 determines the level (one of levels 1 to 4) related to the degree D_{w} of rutting for each point Pᵢ or section Sᵢ included in the travel route by using the mean μ and the standard deviation σ of the population related to the degree D_{w} of rutting based on the same method as that in the first embodiment. Then, the difficulty level calculation unit 314 calculates the difficulty level of the travel route for each point Pᵢ or each section Sᵢ by performing arithmetic-averaging or weighted-averaging on the level of the curvature change Cₑ and the level of the degree D_{w} of rutting. Then, the difficulty level calculation unit 314 stores the calculated difficulty level in the storage unit 32 in association with the information about the point Pᵢ or the section Sᵢ. The process then proceeds to step S28.

In step S28, the driving skill evaluation unit 316 of the processing unit 31 evaluates the driving skill of the driver for each point Pᵢ or each section Sᵢ included in the travel route based on the difficulty level calculated in step S27 and the information about the driving operation acquired in step S21-1, as in the first embodiment. The process then proceeds to step S29.

In step S29, the presentation processing unit 317 of the processing unit 31 performs a process of feeding back the evaluation result of the driving skill obtained in step S28 to the driver in the same manner as in the first embodiment. Subsequently, the process ends.

### 2-3. Conclusion

As described above, the information processing apparatus 30 according to the second embodiment is a device that calculates the difficulty level of a predetermined route R₀. In particular, the processing unit 31 of the information processing apparatus 30 determines the attribute of the predetermined route R₀. Then, the processing unit 31 acquires information about a plurality of routes Rᵢ each having an attribute similar to the determined attribute. Then, based on the acquired information about the plurality of routes Rᵢ, the processing unit 31 calculates a first probability distribution indicating the occurrence tendency of a value indicated by one or more first indicators related to the geographical feature in all of the plurality of routes Rᵢ. In addition, based on the acquired information about the plurality of routes Rᵢ, the processing unit 31 calculates a second probability distribution indicating the occurrence tendency of a value indicated by one or more second indicators related to the road surface condition in all of the plurality of routes Rᵢ. Then, the processing unit 31 calculates the difficulty level of the predetermined route R₀ based on (i) the position, in the first probability distribution, of the value indicated by the one or more first indicators at the point Pᵢ or the section Sᵢ included in the predetermined route R₀, and (ii) the position, in the second probability distribution, of the value indicated by the one or more second indicators at the point Pᵢ or the section Sᵢ included in the predetermined route R₀.

According to such a configuration, in addition to the population of the first indicator related to the geographical feature in the plurality of routes Rᵢ each having the attribute similar to the predetermined route R₀, the population of the second indicator related to the road surface condition is taken into consideration, whereby, for example, the difficulty level of the predetermined route R₀ can be calculated objectively in consideration of information that cannot be obtained from the map information. The second embodiment is similar to the first embodiment in that, even when the difficulty level of the predetermined route R₀ alone is high, the difficulty level of the predetermined route R₀ is calculated to be low if the difficulty level of the plurality of routes Rᵢ having similar attributes to the predetermined route R₀ is low as a whole. Therefore, the difficulty level of the target route can be evaluated objectively by taking into consideration various routes each having an attribute similar to that of the target route. As a result, the driving skill of the driver can be objectively evaluated by using such a difficulty level for the evaluation of the driving skill of the driver.

Preferred embodiments of the present disclosure have been described above in detail with reference to the accompanying drawings, but the present disclosure is not limited to such examples. It will be apparent to those skilled in the art to which the present disclosure belongs that various modifications and variations can be made without departing from the technical scope of the present disclosure as defined by the appended claims, and it is to be understood that such modifications and variations belong to the technical scope of the present disclosure. For example, the functions and the like included in each component, each step, or the like can be rearranged so as not to be logically inconsistent, and a plurality of components, steps, or the like can be combined into one or can be divided.

The technology of the present disclosure can also be realized as the vehicle 10 including the information processing apparatus 30 described in each of the above-described embodiments, an information processing method executed by the information processing apparatus 30, a computer program that causes a computer to function as the above-described information processing apparatus 30, and a non-transitory tangible recording medium in which the computer program is recorded.

According to an embodiment of the present disclosure, the difficulty level of a target route can be evaluated objectively by taking into consideration various routes each having an attribute similar to the target route.

The information processing apparatus 30 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the information processing apparatus 30 including the processing unit 31, the storage unit 32, and the communication unit 33. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. An information processing apparatus configured to calculate a difficulty level of a predetermined route, the information processing apparatus comprising:
one or more processors and one or more memories communicably coupled to the one or more processors,
wherein the one or more processors are configured to
determine an attribute of the predetermined route,
acquire information about a plurality of routes each comprising an attribute similar to the determined attribute,
calculate a first probability distribution based on the acquired information about the routes, the first probability distribution indicating an occurrence tendency of a value indicated by at least one first indicator related to a geographical feature in all of the routes, and
calculate the difficulty level of the predetermined route based on a position, in the first probability distribution, of the value indicated by the at least one first indicator at a predetermined point or in a predetermined section included in the predetermined route.

2. The information processing apparatus according to claim 1,
wherein the predetermined route is a travel route of a vehicle driven by a driver whose driving skill is to be evaluated, and
wherein the one or more processors are configured to
calculate the difficulty level at the predetermined point or in the predetermined section based on the position, in the first probability distribution, of the value indicated by the at least one first indicator,
acquire information about a driving operation by the driver at the predetermined point or in the predetermined section, and
evaluate the driving skill of the driver at the predetermined point or in the predetermined section based on the calculated difficulty level and the acquired information about the driving operation.

3. The information processing apparatus according to claim 1,
wherein the one or more processors are configured to
further calculate a second probability distribution based on the acquired information about the routes, the second probability distribution indicating an occurrence tendency of a value indicated by at least one second indicator related to a road surface condition in all of the routes, and
calculate the difficulty level of the predetermined route based on the position, in the first probability distribution, of the value indicated by the at least one first indicator at the predetermined point or in the predetermined section and a position, in the second probability distribution, of the value indicated by the at least one second indicator at the predetermined point or in the predetermined section.

4. The information processing apparatus according to claim 3,
wherein the predetermined route is a travel route of a vehicle driven by a driver whose driving skill is to be evaluated, and
wherein the one or more processors are configured to
calculate the difficulty level at the predetermined point or in the predetermined section based on the position, in the first probability distribution, of the value indicated by the at least one first indicator and the position, in the second probability distribution, of the value indicated by the at least one second indicator,
acquire information about a driving operation by the driver at the predetermined point or in the predetermined section, and
evaluate the driving skill of the driver at the predetermined point or in the predetermined section based on the calculated difficulty level and the acquired information about the driving operation.

5. The information processing apparatus according to claim 2,
wherein the one or more processors are configured to
present, to the driver, the difficulty level of the driving operation and the driving operation by the driver at the predetermined point or in the predetermined section in association with each other.

6. The information processing apparatus according to claim 4,
wherein the one or more processors are configured to
present, to the driver, the difficulty level of the driving operation and the driving operation by the driver at the predetermined point or in the predetermined section in association with each other.
